(19) United States
(12) Patent Application Publication
(10) Pub. No.: US 2017/0310939 A1
(43) Pub. Date: Oct. 26, 2017

(54) KEYBOARD DEVICE WITH PROJECTING FUNCTION AND ANTI-SHAKING METHOD FOR PROJECTION

(71) Applicant: HEROIC POWER CO., LTD, Shenzhen City (CN)

(72) Inventor: Yao-Chung LIN, Taipei City (TW)

(21) Appl. No.: 15/495,024

(22) Filed: Apr. 24, 2017

(30) Foreign Application Priority Data
Apr. 26, 2016 (CN) 201610262290.6

(51) Int. Cl. H04N 9/31; G06T 5/00; G06F 3/02

(52) U.S. Cl. CPC H04N 9/3188; H04N 9/3185; G06F 3/021; G06T 5/002; G06T 5/003

(57) ABSTRACT

A keyboard device includes a keyboard body including a plurality of keys. A projector is disposed in the keyboard body for receiving and transforming an image signal into a projection frame, and projecting the projection frame on a projection plane. A vibration sensor is disposed in the keyboard body, and generates a vibration signal in response to a vibration of the keyboard body. A microprocessor is in communication with the vibration sensor and the projector, dynamically adjusts the image signal according to the vibration signal, and outputs the adjusted image signal to the projector to generate the projection frame corresponding to the adjusted image signal. The shaking problem of the projection frame can thus be ameliorated.

### FIELD OF THE INVENTION

The present invention relates to a keyboard device, and more particularly to a keyboard device with a projecting function. The present invention also relates to an anti-shaking method, and more particularly to an anti-shaking method for projection.

### BACKGROUND OF THE INVENTION

From notebook computers, tablet computers to smart phones, the development of portable information devices tends to being as compact as possible. Therefore, the display size of a portable information device is generally too small to be used for briefing or presentation. Instead, a projector is commonly used. On the other hand, the commercial available projectors are too bulky and too heavy to be carried. Therefore, designers try to miniaturize projectors or integrate a projector into a portable device such as a smart phone. For example, there has been developed a keyboard device integrated with a built-in projector, as shown in FIG. 1A. As shown, a projector module 10 is built in a keyboard body 1. However, there is a serious problem with the use of a projector built in a keyboard. The keyboard body 1, as indicated by an arrow 11, might vibrate when the user is tapping the button, causing the projection screen to shake, as indicated by an arrow 12, or distort, seriously affecting the stability of the projection screen, and resulting in unpleasant viewing experience, as schematically shown in FIG. 1B.

With respect to the image stabilization function of a projector, the “laser projector anti-shake frame-correcting device” has been published with the Chinese Patent Publication No. CN204964974U, but it is mainly carried out by a drive mechanism to accurately move the optical compensation mechanism so as to accomplish the correction of the frame image. However, the technical means by which the movable mechanism is utilized is not suitable for use in a miniaturized projection apparatus because the overly complicated mechanism is not advantageous for assembling into a compact case and is disadvantageous in cost reduction.

### SUMMARY OF THE INVENTION

Therefore, the present invention provides an anti-shaking method for projection, which utilizes a feedback mechanism to achieve a good compensation effect, thereby resolving a shaking problem of a projection frame.

The present invention further provides a keyboard device, which can perform a shake-free projecting function.

In an aspect of the present invention provides a keyboard device, which comprises a keyboard body including a plurality of keys; a projector disposed in the keyboard body for receiving and transforming an image signal into a projection frame, and projecting the projection frame on a projection plane; a vibration sensor disposed in the keyboard body, generating a vibration signal in response to a vibration of the keyboard body; and a microprocessor in communication with the vibration sensor and the projector, dynamically adjusting the image signal according to the vibration signal, and outputting the adjusted image signal to the projector to generate the projection frame corresponding to the adjusted image signal.

In another aspect of the present invention, the present invention provides an anti-shaking method for a projection frame, which is adapted to be used in a keyboard device with a built-in projector. The method comprises receiving an image signal; generating a vibration signal in response to a vibration of the keyboard device; dynamically adjusting the image signal according to the vibration signal; and projecting a projection frame corresponding to the adjusted image signal on a projection plane.

### BRIEF DESCRIPTION OF THE DRAWINGS

The invention will become more readily apparent to those ordinarily skilled in the art after reviewing the following detailed description and accompanying drawings, in which:

FIG. 1A is a schematic diagram illustrating a keyboard device with a built-in projector;

FIG. 1B is a schematic diagram illustrating frame shaking with vibration of the keyboard device as shown in FIG. 1A while being typed;

FIG. 2 is a functional block diagram illustrating a keyboard device according to an embodiment of the present invention;

FIG. 3 is a schematic diagram exemplifying dynamic adjustment of a projection frame conducted by an anti-shaking method according to an embodiment of the present invention; and

FIG. 4 is a schematic diagram exemplifying dynamic adjustment of a projection frame conducted by an anti-shaking method according to another embodiment of the present invention.

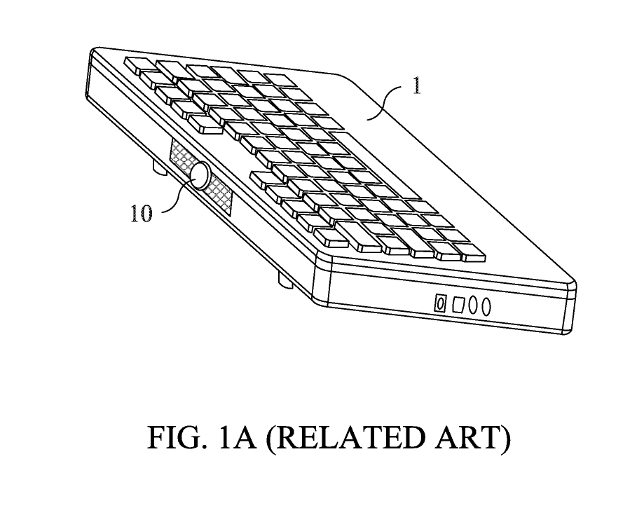

### DETAILED DESCRIPTION OF PREFERRED EMBODIMENTS

The invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

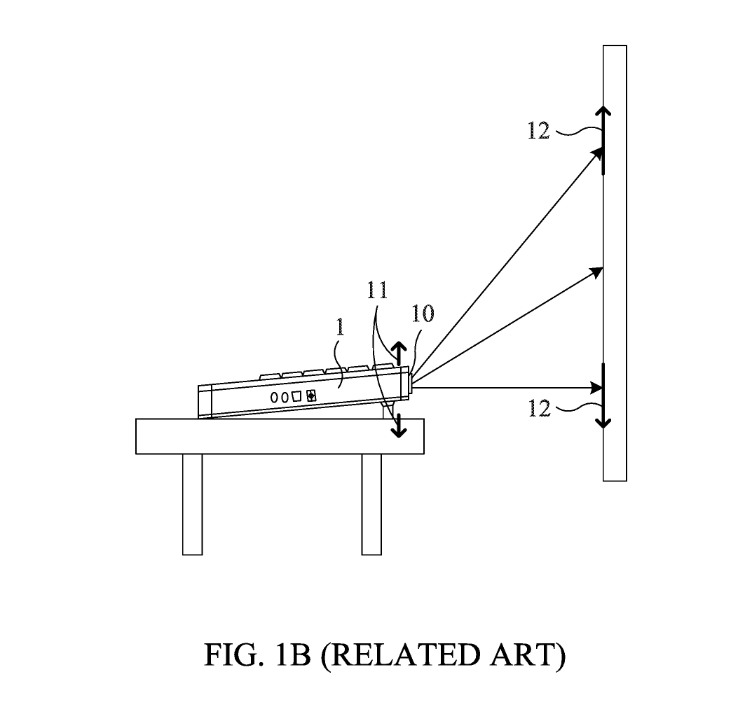

Referring to FIG. 2, there is shown a functional block diagram of a keyboard device having a built-in shockproof projection function according to an embodiment of the present invention. The keyboard device comprises a keyboard body 2 having a plurality of keys 20 thereon, and a projector module 21 is provided in the keyboard body 2 for receiving a video signal and converting it into a projection frame, which is projected onto the projection plane 25. The projection plane 25 may be a screen, a desk, a wall, a ceiling, a floor, or any other object that can be projected on. The source of the video signal may be a source of various types of video signals inputted from the video input terminal 29 by an external computer host (not shown) or an optical disk player (not shown). A vibration sensor 22 is provided in the keyboard body 2 for generating a vibration signal in response to the vibration of the keyboard body 2, e.g. the vibration caused by hand-held rocking, typing on the keyboard, shaking the base, and the like. The vibration sensor 22 may be implemented with one of a multi-axial electronic gyroscope and an accelerometer, or the combination thereof. The resulting vibration signal correlates to a vibration angle and an acceleration level rendered as using the keyboard body 2. The vibration signal is then outputted to the microprocessor 23.

The microprocessor 23 is in communication with the vibration sensor 22 and the projector module 21. The microprocessor 23 dynamically adjusts the received image signal in response to the vibration signal and outputs it to the projector module 21 to generate a shaking-free projection frame. For example, the information contained in the vibration signal can be decomposed into two kinds of shifts. The first part of the information is a first-directional vibration information, wherein the first direction is orthogonal to the normal vector of the projection frame, and the second part of the information is a second-directional vibration information, wherein the second direction is parallel to the normal vector of the projection frame. The vibration in the first direction would cause a shift of the projection frame in parallel to the projection plane. The microprocessor 23 dynamically adjust the received image signal in accordance with the first-directional vibration information so that the image frame outputted to the projector module 21 would move in an opposite direction of vibration, thereby compensating for the effect caused by vibration of the keyboard body.

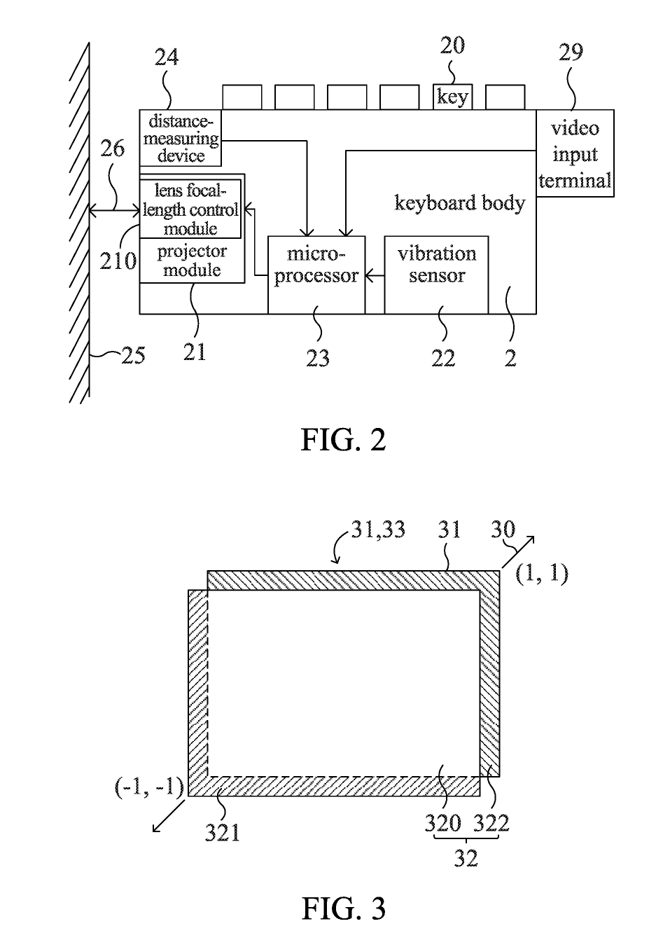

Please refer to FIG. 3, which schematically exemplifies dynamic adjustment for an image signal. In this example, the first-directional vibration information is a shift vector information 30 shown in the figure, which indicates a vibration direction resulting from the use of the keyboard body 2, and the vibration can be compensated in the following way. The microprocessor 23 processes the original image signal to shift the pixel coordinates of the original frame 31 toward the opposite direction of the shift vector information 30. For example, the shift vector information 30 is (1,1), then the counter direction is (−1, −1), and the microprocessor 23 shifts the pixel coordinates of the original frame along the vector (−1, −1). Furthermore, the pixel point set of an edge portion crossing the display area 33, i.e. the area coinciding with the original frame 31, will be cut off, and the blank area 322 may be compensated with the neighboring pixel points. Accordingly, a shaking-free frame 32 with the same pixel number can be formed by combining the compensated area 322 with the shifted pixel point set 320.

When there is vibration in the second direction, it means that the projection frame would be blurred in the focusing direction. Under this circumstance, the microprocessor 23 cooperates with the lens focal-length control module 210 in the projector module 21 to have the lens focal-length control module 210 adjust the projection focal-length according to the second-directional vibration information in real time, thereby keeping the projection frame clear and stable. Of course, if the vibration level in the second direction is substantially neglectable in comparison with the depth of field of the lens, the adjustment in the second direction can be omitted.

On the other hand, when an amplitude of the vibration signal, which represents a vibration level of the keyboard body, is greater than a predetermined threshold value, it is determined that the vibration is perceivable by human eyes and that image stabilization is required. Therefore, the microprocessor 23 performs the above-described compensation action for the projection frame. This mechanism will prevent the microprocessor 23 from performing unnecessary operations. Furthermore, the microprocessor 23 may initiate a function of lowering a frame rate of the projection frame when the amplitude of the vibration signal is greater than a preset threshold. For example, the frame rate may be reduced from 60 images per second down to 30 frames per second or 24 images per second, to enhance the effect of anti-shaking. Alternatively, the microprocessor 23 may initiate a function of lowering the frame resolution when the amplitude of the vibration signal is greater than a preset threshold. For example, the frame resolution may be reduced from 1920*1080 to 1280*720, to enhance the effect of image stabilization. Of course, both the frame rate and the frame resolution may be reduced to enhance the effect of anti-shaking. In another alternative example, it is also possible to start a line edge anti-aliasing function on the projection frame when the amplitude of the vibration signal is greater than a preset threshold. The above functions are useful for adjusting the projection frame or video signal.

According to another embodiment of the present invention, a keyboard device may further comprise a distance-measuring device 24. The distance-measuring device 24 is in communication with the microprocessor 23 for measuring a projection distance 26 between the projector module 21 and the projection plane 25. The resulting projection distance is provided for the reference of the microprocessor 23 to tune the compensation effect. When the projection distance is changed, the adjustment of the video signal and the projection focal-length needs to be changed as well. For example, when the projection distance is increased, the variation of the image signal and the projection focal-length needs to be rectified, so that the image shaking caused by the vibration of the keyboard body can be compensated with improved precision. For example, the distance-measuring device may be an infrared distance-measuring module or other sensing module which can be used for ranging.

In addition, the projection distance obtained by the distance measuring device 24 can also be used to automatically control the size of the projection frame. For example, for maintaining the projection frame at a fixed size, the magnification ratio of the projection frame needs to be varied with the measured projection distance. For example, when the projection distance becomes smaller, the projection frame would also become smaller, so the magnification ratio of the projection frame needs to be enlarged to maintain the frame at the fixed size.

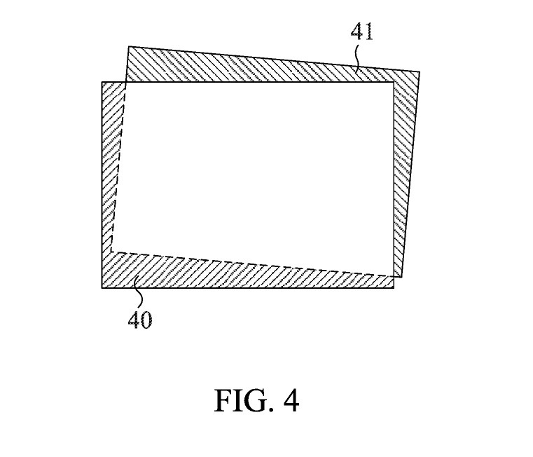

Furthermore, the vibration sensor 22 may include a plurality of subunits disposed on the keyboard body 2. The plurality of subunits may be integrated in substantially the same position or distributed in different positions. The subunits send respective vibration information to the microprocessor 23. Then the microprocessor 23 collects and analyzes the vibration information for estimating a frame skew level. For example, as shown in FIG. 4, a frame skew occurs as typing keyboard causes the shift of the original frame 40 into a skew frame 41. It is understood that the skew data includes at least a translation-vector data and a rotation-angle data. Therefore, at least two kinds of sub-units are used in the vibration sensor 22 for generating respective vibration information so as to obtain the translation-vector data and the rotation-angle data.

The anti-shaking method for a projection frame according to the present invention and its details, as well as achievable effects, can be understood with reference to the above description of the details of the keyboard device. Nevertheless, in addition to a keyboard device, the hardware architecture and the anti-shaking method for a projection frame according to the present invention may also be applied to other similar handheld electronic devices such as mobile phones, personal digital assistants (PDAs), tablet computers, digital cameras, digital video cameras, portable multimedia devices, or other suitable handheld devices, and the vibration sensors originally equipped in the devices can alternatively be used for the anti-shaking purpose.

By way of the above-described apparatus and method, the shaking problem of a projection frame, resulting from user's operation on the keyboard body, can be ameliorated as a result of dynamic compensation. Moreover, the apparatus and method proposed in the embodiments of the present invention are particularly suitable for use in miniaturized portable electronic devices, thereby improving the prior art.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the claims which are to be accorded with the broadest interpretation so as to encompass all such modifications and similar structures.

What is claimed is:

1. A keyboard device, comprising:
a keyboard body including a plurality of keys;
a projector disposed in the keyboard body for receiving and transforming an image signal into a projection frame, and projecting the projection frame on a projection plane;
a vibration sensor disposed in the keyboard body, generating a vibration signal in response to a vibration of the keyboard body; and
a microprocessor in communication with the vibration sensor and the projector, dynamically adjusting the image signal according to the vibration signal, and outputting the adjusted image signal to the projector to generate the projection frame corresponding to the adjusted image signal.

2. The keyboard device according to claim 1, wherein the vibration sensor is implemented with one of a multi-axial electronic gyroscope and an accelerometer, or the combination thereof.

3. The keyboard device according to claim 2, wherein the vibration signal contains information including a first-directional vibration information, which correlates to a shift of the projection frame in parallel to the projection plane, and the first direction is a direction orthogonal to a normal vector of the projection frame.

4. The keyboard device according to claim 3, wherein the microprocessor dynamically adjusts the image signal to have the projection frame moved in a direction opposite to the shift of the projection frame.

5. The keyboard device according to claim 3, wherein the information of the vibration signal further includes a second-directional vibration information, which correlates to a shift of the projection plane in projection focal-length, and the second direction is parallel to the normal vector of the projection frame.

6. The keyboard device according to claim 1, wherein the microprocessor dynamically adjusting the image signal when an amplitude of the vibration signal, which represents a vibration level of the keyboard body, is greater than a threshold value.

7. The keyboard device according to claim 1, wherein the microprocessor lowers a frame rate and/or resolution of the projection frame when an amplitude of the vibration signal is greater than a preset threshold.

8. The keyboard device according to claim 1, further comprising a distance-measuring device in communication with the microprocessor for measuring a projection distance between the projector and the projection plane, wherein the microprocessor dynamically adjusts a magnification ratio of the projection frame according to the projection distance.

9. An anti-shaking method for a projection frame, adapted to be used in a keyboard device with a built-in projector, comprising:
receiving an image signal;
generating a vibration signal in response to a vibration of the keyboard device;
dynamically adjusting the image signal according to the vibration signal; and
projecting a projection frame corresponding to the adjusted image signal on a projection plane.

10. The method according to claim 9, wherein the vibration signal is generated by one of a multi-axial electronic gyroscope and an accelerometer, or the combination thereof.

11. The method according to claim 10, wherein the vibration signal contains information including a first-directional vibration information and a second-directional vibration information, wherein the first direction is a direction orthogonal to a normal vector of the projection frame, and the second direction is a direction parallel to the normal vector of the projection frame.

12. The method according to claim 11, wherein the image signal is dynamically adjusted according to the first-directional vibration information to have the projection frame moved in a direction opposite to a shift of the projection frame.

13. The method according to claim 9, wherein the image signal is dynamically adjusted when an amplitude of the vibration signal is greater than a threshold value.

14. The method according to claim 9, wherein a frame rate and/or resolution of the projection frame is lowered when an amplitude of the vibration signal is greater than a preset threshold.

15. The method according to claim 9, further comprising a step of measuring a projection distance between the projector and the projection plane, wherein a magnification ratio of the projection frame is dynamically adjusted according to the projection distance.
